(19) United States
(12) Patent Application Publication
(10) Pub. No.: US 2013/0033393 A1
(43) Pub. Date: Feb. 7, 2013

(54) System and Method for Suppressing Interference in Frequency-Modulated Radar Systems

(71) Applicants: Christian Helbig, Ruderatshofen (DE); Felix Aertz, Mauerstetten (DE); Thomas Ostertag, Geretsried (DE); Rudiger Hutter, Geretstried (DE)

(72) Inventors: Christian Helbig, Ruderatshofen (DE); Felix Aertz, Mauerstetten (DE); Thomas Ostertag, Geretsried (DE); Rudiger Hutter, Geretstried (DE)

(21) Appl. No.: 13/574,907

(22) PCT Filed: Jan. 21, 2011
(86) PCT No.: PCT/EP11/00233

§ 371 Date: Oct. 15, 2012

(30) Foreign Application Priority Data
Jan. 29, 2010 (DE) 10 2010 006 334.7

(51) Int. Cl. G01S 13/34

(52) U.S. Cl. 342/200

(57) ABSTRACT

The invention relates to a system having an emitter for emitting a first microwave radiation, a receiver for detecting a second microwave radiation derived from the first microwave radiation and a control system connected to the emitter and the receiver. The first microwave radiation is emitted at a plurality of points in time at different frequencies assigned to the points in time. The correlation of point in time and frequency is random or pseudo-random. Alternatively or additionally, at the point in time, the length of the time period for an emission or reception is random or pseudo-random. The invention further relates to a method for suppressing interference in frequency-modulated radar systems.

The invention relates to a system and a method for suppressing interference in frequency-modulated radar systems.

Low-power radar systems usually use a scanning process in which individual discrete frequencies are successively scanned in a fixed time and frequency raster. Subsequently, the pulse response can be calculated via an inverse Fourier transformation of the received detected signal. The field of application of such radar systems is the reading of reflective surface-wave delay lines, fill level radar systems and radar range finders. The evaluation of the detected measuring signal is often problematic as a result of high number of artifacts in these systems which usually use low scanning and emission powers.

It is therefore the object of the present invention to prevent artifacts occurring in the evaluation of the measuring signal generated by time and frequency scanning.

This object is achieved by a system and a method according to the main claims. Advantageous further developments of the invention are provided in the dependent claims.

It was surprisingly noticed that artifacts which are produced in periodic fluctuations of the detected reflected power can be avoided when avoiding a fixed time-frequency allocation in scanning. As a result, periodic changes in the detected reflected power are no longer fed into the Fourier transformation as frequency-periodic input signal and therefore do not generate any discrete line in the transformation area. The interference is therefore transformed into a noise signal especially when using a pseudo-randomly distributed scanning raster in the time range.

The system in accordance with the invention therefore comprises a transmitter for emitting a first microwave radiation especially for scanning, a receiver for detecting a second microwave radiation derived from the first microwave radiation. Depending on the application, said second microwave radiation can concern a direct or indirect reflex or a second microwave radiation generated after the reception of the first microwave radiation. Transmitter and receiver are connected with a control unit. It can concern a common control unit for example or one respective control for transmitter and receiver. The control unit is configured to control the emission of the first microwave radiation and, in the detection of the second microwave radiation, to correlate and evaluate the same with the first microwave radiation among other things. The first microwave radiation will be emitted at a plurality of points in time. The individual points in time are respectively allocated to different frequencies. They can concern individual discrete frequencies which are intended to cover a specific frequency range for example. It is also possible to scan several separate frequency ranges separately or to emit only respective individual discrete frequencies. Alternatively, it is also possible to perform a continuous modulation of the frequency of the first microwave radiation over a specific time and frequency range.

In accordance with the invention, two alternative concepts are provided for avoiding the occurrence of artifacts, which can advantageously also be combined with one another. It can be provided on the one hand that the allocation of the point in time at which the first microwave radiation is emitted is random or pseudo-random to the frequency of said first microwave radiation. The aforementioned elimination of the fixed time frequency scanning raster prevents that periodic changes in the power of the second microwave radiation will lead to artifacts.

It can alternatively or additionally be provided that at the point in time at which the first microwave radiation is emitted the length of the period of time which is required for emission or receiving is random or pseudo-random. The variation in the length in the emission period also ensures in a directly successive sequence of the emission periods that no direct relationship will arise between the emission point in time and the emission frequency. Similarly, the period for receiving the derived second microwave radiation can be varied in a random or pseudo-random fashion, e.g. averaging of the detected second microwave radiation which occurs in a differently long manner. Both alternative solutions therefore realize the inventive idea, which is an elimination of a fixed periodic allocation of time and frequency in the emission of a microwave interrogation or scanning signal.

The system can concern a radar system. In the present case, the term of radar shall be understood as being the emission of an electromagnetic wave, the wavelength of which lies between one meter and one millimeter, corresponding to a frequency range of approximately 300 MHz up to approximately 300 GHz, as the first or primary microwave radiation and the reception of a second or secondary microwave radiation (e.g. reflected radiation) derived therefrom. The field of application for such a radar system shall not exclusively be the location of an object, but it shall include all fields of application such as the interrogation of information from remote sensors or the detection of filling levels, speed etc.

Radar principles conventionally used in the field of radar such as pulse, chirp or FMCW can be used in this connection for generating the second microwave radiation and evaluating the information conveyed with said radiation. A short electrical pulse or a short wave packet is emitted in the pulse method as first microwave radiation. This interrogation signal will meet an object after a specific running period. After a further time interval a respective response signal is received as second microwave radiation. Conclusions on the distance for example in a fill level radar for example can be derived from the interval between the emission of the pulse or wave packet and the impingement of the response signal.

In the FMCW method (FMCW radar=Frequency Modulated Continuous Wave Radar, modulated continuous-wave radar), the first microwave radiation is emitted continuously as a continuous wave and its frequency is modulated, which means the frequency rises linearly for example in order to be abruptly set back to the initial value at a specific frequency. As an alternative to such a sawtooth pattern, the frequency can also rise and drop in a continuously alternating fashion, or also be modulated in other ways. The frequency of the signal of the second microwave radiation received in a time-staggered manner is shifted by a specific difference in relation to the frequency of the first microwave radiation since the frequency of the first microwave radiation will change during the signal propagation. A distance can be determined for example from this difference in frequency.

Frequency-modulated pulses are used as the first microwave radiation in the chirp method.

According to an advantageous further development of the invention, the transmitter emits the first microwave radiation with variable frequency. The transmitter comprises a frequency modulator for the first microwave radiation for this purpose for example. This is advantageous especially in connection with the aforementioned FMCW or chirp method.

It can be provided for the advantageous further development of the idea of eliminating a fixed allocation of time and frequency, i.e. the principal of random or pseudo-random allocation of time and frequency, that the frequencies are arranged in an equidistant manner. They can especially be arranged in a list. As a result of the random selection of the emission frequencies from the list of equidistant frequencies, i.e. by said random hopping of the emission frequency of the first microwave radiation, a fixed phase relationship is avoided between a periodic power fluctuation of the second microwave radiation and the emission time of the first microwave radiation and the artifacts that potentially occur thereby.

It can alternatively or additionally be provided that the waiting time between the frequencies is random or pseudo-random. As a result of the random distribution of the waiting times, a fixed relationship between power fluctuations and the times of the interrogation transmission frequencies which otherwise causes artifacts is also eliminated.

It can further be provided that the receiver comprises an averaging apparatus for averaging measurements, with the number of averagings being random or pseudo-random. This is especially advantageous when the time between the emission of the first microwave radiation and the reception of the second microwave radiation is short and a plurality of measurements or interrogations can be performed within a period of time. The use of the averaging apparatus per se allows an improvement of the noise-to-signal ratio. The random or pseudo-random number of averagings generates the artifact-preventing effect as already mentioned above.

It can be provided in a special embodiment of the invention that the system comprises a sensor with an interdigital transducer which converts the first microwave radiation into a surface wave and generates the second microwave radiation. It can further be provided that the sensor comprises an antenna, a piezoelectric crystal and a reflector, and in addition a resonator or a delay line. Such a sensor is also known as a surface-wave radio sensor. The interdigital transducer can be applied to a thin platelet of a piezoelectric crystal in form of a comb-like micro-structured metallization and can be connected with an antenna. The reflector or reflectors can be arranged for example as micro-structured metallizations on the substrate surface of the sensor. The first microwave radiation is received by the antenna of the sensor and is converted by means of the interdigital transducer into a propagating mechanical surface wave with the help of the inverse piezoelectric effect. One or several reflectors are attached in a characteristic sequence for example in the direction of propagation of said surface wave. They will reflect the surface wave and send it back to the transducer. They are converted there via the direct piezoelectric effect into electromagnetic waves and emitted by the antenna as second microwave radiation.

In order to achieve a separation between the first microwave radiation and the second microwave radiation, structures can be provided on the sensors which allow a separation in the time range and/or in the frequency range. The use of a delay line and/or a resonator allows that the first microwave radiation is stored on the sensor for such time until the electromagnetic ambient echoes have decayed. A positive aspect is that the propagation speed of an acoustic surface wave is typically only 3500 m/s. It is further possible to use interdigital transducers which excite surface waves by a so-called double shift keying in different frequencies. A frequency dependence of the acoustic properties is additionally obtained thereby in the sensor.

It can especially be provided in an advantageous embodiment that the second microwave radiation comprises information on the identity of the sensors and/or on a measuring quantity detected by the sensor. For impressing a sensor identity onto the second microwave radiation, partly reflecting structures can be provided in a characteristic sequence in the direction of propagation of the surface wave. If the first microwave radiation consists of a single interrogation pulse for example, a plurality of pulses is produced by the aforementioned structures which are reflected back by the interdigital transducer and are converted there into electromagnetic waves again and are emitted by the antenna. The sensor can be arranged alternatively or additionally in such a way for example that the propagation speed of the surface wave will change depending on the measuring quantity. As a result, the center frequency and the running time of the surface wave sensor will change, which therefore accordingly changes the second microwave radiation emitted by the antenna and therefore impresses the measuring quantity.

It can especially be provided that the sensor may detect one or several of the following measuring quantities: temperature, force, acceleration, mechanical tension, torque. Lithium niobate can be provided as a suitable sensor material for detecting the temperature.

An advantageous embodiment of the invention provides that the system is arranged for detecting an operating state of a rotating, oscillating and/or vibrating apparatus. The initially mentioned undesirable correlation between a periodic signal power fluctuation and the frequency of the first microwave radiation (i.e. interrogation radiation) can occur especially in periodically repeating movements such as those mentioned above. In this connection, the aforementioned decoupling by introducing a random or pseudo-random allocation of frequency and time and/or by arranging the length of the emission and receiving period in a random or pseudorandom manner is advantageous.

A concrete application of the aforementioned embodiment is provided in such a way that the apparatus comprises a gear and the sensor is arranged within the gear. The sensor can be attached to the bearing shells of the housing. Alternatively or additionally it can also be provided on parts moved within the housing. It can be especially provided in this connection that a transmitting and receiving antenna is placed within the gear housing which is guided to the outside via a lead-through and a connector for example. As a result, it is not necessary to provide any wiring to the temperature sensor for example apart from the lead-through of the antenna within the housing because wireless transmission can occur within the gear.

Further advantageous configurations of the system in accordance with the invention and/or the method in accordance with the invention are provided from the embodiment which will be described below in closer detail by reference to the drawing, wherein:

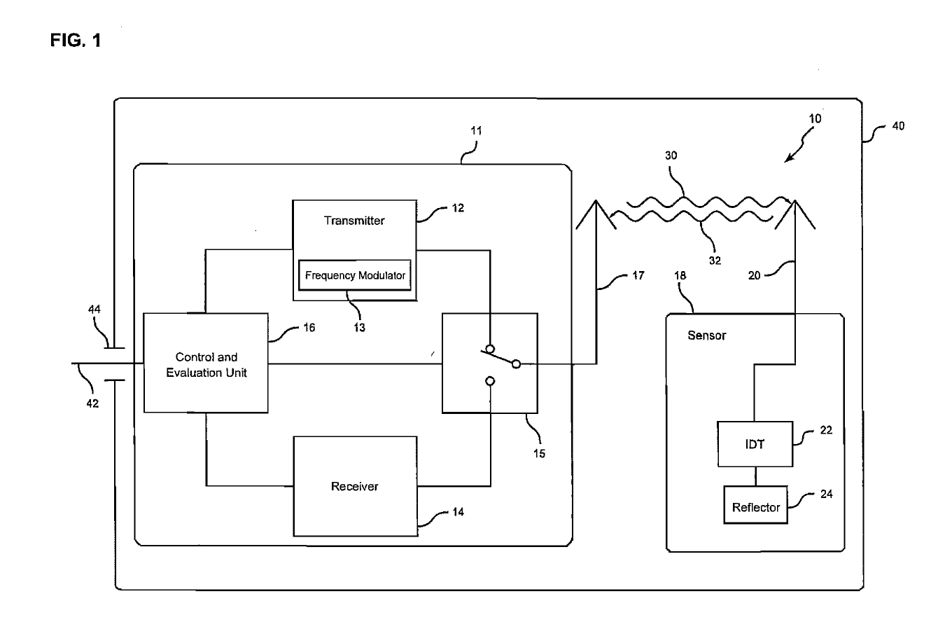

FIG. 1 shows an exemplary radar system in accordance with the invention.

FIG. 1 shows a frequency-modulated radar system 10 in accordance with the invention. The system 10 comprises an interrogation apparatus 11 and a sensor 18. The interrogation apparatus 11 comprises a transmitter 12, a receiver 14 and a control and evaluation unit 16. A switch 15 and an emitting and receiving antenna 17 are further provided.

The transmitter 12 generates an electromagnetic high-frequency pulse in the microwave range, i.e. between approximately 300 MHz and approximately 300 GHz. Within Europe there are two frequency bands in which the operation of a low-power transmitter is permitted for industrial, scientific and medical purposes (ISM bands). They are at 433 MHz and 2.4 GHz. An additional ISM band is at 868 MHz. The use of the so-called ultra-wideband (UWB) is also possible. The high-frequency pulse is frequency-modulated by a frequency modulator 13 included in the transmitter 12. It will be transmitted as an interrogation signal 30 via the antenna 17 once the switch 15 has been brought to the respective position by the control 16. The receiver 14 will receive a response signal 32 via antenna 17 at a respective position of the switch 15. It will be detected and evaluated by the control and evaluation unit 16. The control unit 16 assumes the time- and frequency-related control of the transmitter 12 and the receiver 14 among other things and produces a correlation of the transmission and receiving parameters.

The sensor 18 comprises an antenna 20, an interdigital transducer 22 and a reflector 24. The electromagnetic high-frequency interrogation signal 30 which is transmitted by the antenna 17 of the interrogation apparatus 11 will be received by the antenna 20 of the sensor 18 and will be converted into a microacoustic surface wave by means of the interdigital transducer 22. The interdigital transducer 22 comprises a comb-like microstructured metallization for this purpose which generates the surface wave by means of the inverse piezoelectric effect. The reflector 24 is also a microstructured metallization on the substrate surface of the sensor 18 and reflects the surface wave, which then meets the interdigital transducer 22, is converted by means of the piezoelectric effect into electrical signals and is emitted by the antenna 20 as a response signal 32.

The response signal contains information on the number and position of the reflectors, the reflection factor and the propagation speed of the acoustic wave. The response signal 32 will be received and evaluated by the interrogation apparatus 11. The propagation speed of an acoustic surface wave is typically only 3500 m/s. Acoustic surface wave components therefore offer the possibility to store a high-frequency pulse on a small chip for such a time until the electromagnetic ambient echoes have decayed.

The working range of the surface wave sensors 18 extends up to −196° C. at low temperatures. When the surface wave chip 18 is welded in vacuum, the sensor can also be used for ultra-low temperature applications. The aluminum structure of the interdigital transducer 18 will be damaged above 400° C. Furthermore, conventional surface wave crystals such as lithium niobate, lithium tantalite and quartz are suitable for high temperatures only within limits. It is possible however to use langasit and platinum electrodes from a crystal suitable for high temperatures in order to use surface wave radio sensors also up to temperatures of about 1000° C. It is a further advantage of the surface wave sensor system that temperatures of moved objects such as rotating shafts, turbines or centrifuge parts are measured.

In the present embodiment, interrogation apparatus 11 and the sensor 18 are introduced into a schematically indicated gear housing 40. The interrogation apparatus 11 is connected by means of a control and/or signal line 42 with the outside environment of the gear via a suitable lead-through 44 in the gear housing 40. The sensor 18 per se can be placed freely within the gear housing as a result of the existing radio connection with the interrogation apparatus 11 and can perform temperature measurements at especially relevant points for example.

In addition to the measuring quantity of temperature, there are further physical quantities such as pressure, mechanical tension and torque, as well as chemical measuring quantities for detecting and identifying gases or liquids. The major advantage of the described surface wave radio sensor 18 lies in the applicability under difficult industrial conditions such as strong mechanical vibrations, high temperatures, electrically disturbed environments and also explosive gases and hazardous materials. The maximum range of such a surface wave radio sensor 18 depends among other things on the utilized frequency band, the maximum permissible power and the sensor principle (delay line, resonator) and lies between 1 m and 10 m for example.

It is possible to realize both resonators with sustaining oscillations and delay lines with a response pattern in analogy to a barcode. Physical measuring quantities such as temperature or mechanical tension will change the properties of the piezoelectric substrate and therefore the propagation and reflection properties of the surface wave. The measuring quantity will be extracted from the response signal 32 by means of suitable signal processing in the control and evaluation unit 16. As a result of the elimination of the allocation of frequency and time in accordance with the invention, time-periodic processes in the gear 40 for example are no longer frequency-periodic and do not cause any artifacts in the evaluation, but are blurred into a noise. Potential evaluation methods are the fast Fourier transformation (FFT), the chirp or wavelet transformation, and the correlation-based and filter-based methods. Model-based methods such as polynomial fit or least square optimization can also be used alternatively or in addition.

The aforementioned disturbances can be produced by periodic, rotating or oscillating movement and also by vibrations of the part where the measurement will be performed. Furthermore, gas discharge lamps, periodically modulating reflections or reflections on periodically changing impedances such as a rectifier can also cause the aforementioned artifacts. The mentioned principle of the elimination of a periodic or regular allocation of frequency and time can be used in the surface wave sensor system as mentioned in the embodiment, but also in related methods. These include surface wave identification, fill level radars, radar range finders, distance warning radar, distance-to-fault measurements and network analyzers.

1-14. (canceled)

15. A system comprising:
a transmitter for emitting a first microwave radiation;
a receiver for receiving a second microwave radiation derived from the first microwave radiation;
a control unit connected with the transmitter and the receiver;
the first microwave radiation is transmitted at a plurality of points in time with different frequencies allocated to said points in time;
the allocation of point in time and frequency is random or pseudo-random and/or the length of the time period for the emission or reception is random or pseudo-random;
the system comprises a sensor with an interdigital transducer which converts the first microwave radiation into a surface wave and generates the second microwave radiation.

16. The system according to claim 15, characterized in that the system is a radar system.

17. The system according to claim 15, characterized in that the system is arranged according to the pulse method or the FMCW method or the chirp method.

18. The system according to claim 16, characterized in that the system is arranged according to the pulse method or the FMCW method or the chirp method.

19. The system according to claim 15, characterized in that the transmitter emits the first microwave radiation with variable frequency.

20. The system according to claim 16, characterized in that the transmitter emits the first microwave radiation with variable frequency.

21. The system according to claim 17, characterized in that the transmitter emits the first microwave radiation with variable frequency.

22. The system according to claim 18, characterized in that the transmitter emits the first microwave radiation with variable frequency.

23. The system according to claim 15, characterized in that the frequencies are arranged in an equidistant manner.

24. The system according to claim 16, characterized in that the frequencies are arranged in an equidistant manner

25. The system according to claim 17, characterized in that the frequencies are arranged in an equidistant manner.

26. The system according to claim 15, characterized in that the waiting time between the frequencies is random or pseudo-random.

27. The system according to claim 15, characterized in that the receiver comprises an averaging apparatus for averaging the measurements, with the number of averagings being random or pseudo-random.

28. The system according to claim 15, characterized in that the sensor comprises an antenna and/or a piezoelectric crystal and/or a reflector and/or a resonator and/or a delay line.

29. The system according to claim 15, characterized in that the second microwave radiation is transmitted in a time-staggered manner relative to the first microwave radiation.

30. The system according to claim 15, characterized in that the second microwave radiation comprises information on the identity of the sensor and/or on a measuring quantity detected by the sensor.

31. The system according to claim 15, characterized in that the sensor detects one or several of the following measuring quantities: temperature, force, acceleration, mechanical tension, torque.

32. The system according to claim 15, characterized in that the system is arranged for detecting an operating state of a rotating and/or oscillating and/or vibrating apparatus.

33. The system according to claim 32, characterized in that the apparatus is a gear and/or the sensor is arranged within the gear.

34. A method for suppressing interference in a frequency-modulated radar system, the method comprising:
emitting a first microwave radiation at a first point in time with a first frequency;
receiving a second microwave radiation derived from the first microwave radiation;
emitting the first microwave radiation at a second point in time with a second frequency;
receiving the second microwave radiation derived from the first microwave radiation;
with the second point in time and/or the second frequency being random or pseudo-random with respect to the first point in time and/or the first frequency, or with the length of the period for emission or receiving being random or pseudo-random at the points in time;
the system comprises a sensor with an interdigital transducer which converts the first microwave radiation into a surface wave and generates the second microwave radiation.
